(19) United States
(12) Patent Application Publication
(10) Pub. No.: US 2008/0191531 A1
(43) Pub. Date: Aug. 14, 2008

(54) ADJUSTABLE DEPTH VEHICLE SEAT SYSTEM

(75) Inventor: Ralf Hoffmann, Haag i. OB (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/673,751

(22) Filed: Feb. 12, 2007

(51) Int. Cl. B60N 2/02

(52) U.S. Cl. 297/284.1

(57) ABSTRACT

An adjustable depth seat includes fixed and moveable cushions. The moveable cushion is moveable between retracted and extended positions. In the retracted position, a support cushion is hidden. In the extended position, the support cushion is exposed.

### BACKGROUND OF THE INVENTION

1. Field of the Invention

The invention relates to adjustable depth vehicle seat systems.

2. Discussion

Vehicle seats may need to comfortably accommodate occupants of differing shapes and sizes. Occupant leg support may be important for occupant comfort.

### SUMMARY

Embodiments of the invention may take the form of a seat for an occupant of a vehicle. The seat includes a first element for supporting a first portion of the occupant in a seated position. The first element includes one of a male portion and a female portion. The seat also includes a second element for supporting a second portion of the occupant in the seated position. The second element is moveable relative to the first element between a first position and a second position. The second element includes the other of the male portion and the female portion.

Embodiments of the invention may take the form of a seat for an occupant of a vehicle. The seat includes first and second portions that cooperate to define a seating surface. The second portion is moveable relative to the first portion between first and second positions. The seat also includes a third portion that is hidden if the second portion is in the first position and exposed if the second portion is in the second position. The third portion cooperates with the first and second portions to define a seating surface if the second portion is in the second position.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1A is a side view of adjustable depth seat for an occupant of a vehicle in accordance with an embodiment of the invention;

FIG. 1B is a perspective view of the adjustable depth seat of FIG. 1A and shows the adjustable depth seat in the retracted position;

FIG. 1C is another perspective view of the adjustable depth seat of FIG. 1A and shows the adjustable depth seat in the extended position;

FIG. 2A is a plan view of a portion of the adjustable depth seat of FIG. 1A and shows the adjustable depth seat in the retracted position;

FIG. 2B is a side view, in cross-section, of the adjustable depth seat of FIG. 2A taken along section line 2B-2B of FIG. 2A and shows the mechanism used to move the moveable cushion in the retracted position;

FIG. 2C is another plan view of a portion of the adjustable depth seat of FIG. 1A and shows the adjustable depth seat in the extended position;

FIG. 2D is a side view, in cross-section, of the adjustable depth seat of FIG. 2C taken along section line 2C-2C of FIG. 2C and shows the mechanism used to move the moveable cushion in the extended position; and

FIG. 3 is a side view, in cross-section, of an alternative embodiment of an adjustable depth seat and shows the mechanism used to move the moveable cushion in the extended position.

### DETAILED DESCRIPTION

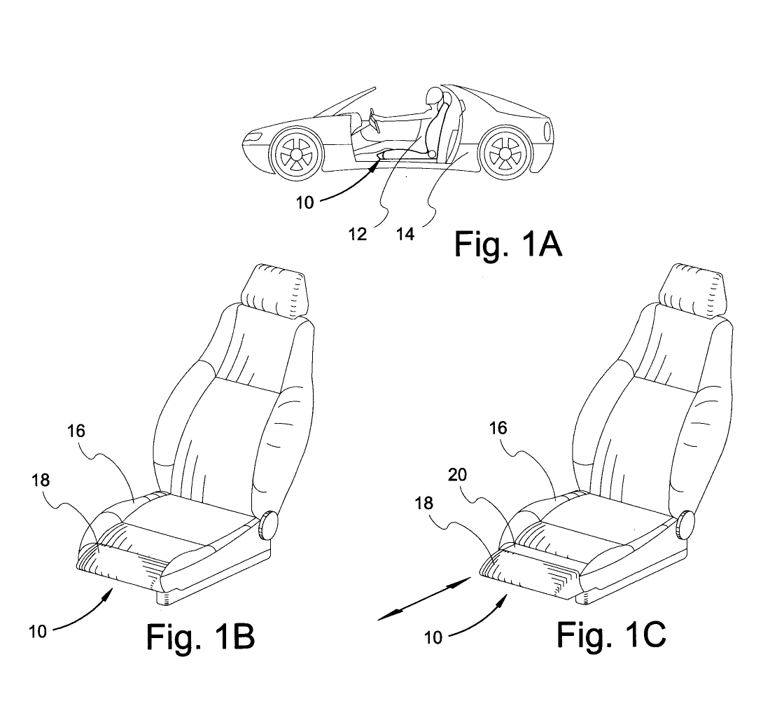

FIG. 1A is a side view of adjustable depth seat 10 for occupant 12 of vehicle 14. As described below, portions of seat 10 are moveable thus allowing occupant 12 to adjust the depth of seat 10 for increased comfort and support. In the embodiment of FIG. 1A, seat 10 is a front seat. In alternative embodiments, seat 10 may be a rear or back seat.

FIG. 1B is a perspective view of seat 10 showing seat 10 in the retracted position. Seat 10 includes fixed cushion 16 and moveable cushion 18. Cushions 16, 18 support occupant 12. In the retracted position, moveable cushion 18 is adjacent fixed cushion 16. Moveable cushion 18 is moveable relative to fixed cushion 16 between retracted and extended positions as described below.

FIG. 1C is another perspective view of seat 10 showing seat 10 in the extended position. In the extended position, moveable cushion 18 is spaced away from fixed cushion 16 thus increasing the depth of seat 10 relative to the retracted position of FIG. 1B.

Seat 10 also includes support 20, e.g., stiff plastic, fabric, leather, foil, or cushion. As described below, support 20 is generally exposed to occupant 12 if moveable cushion 18 is in the extended position and is generally hidden from occupant 12 if moveable cushion 18 is in the retracted position. If exposed, support 20, supports at least a portion of occupant 12. In some embodiments, support 20 is integrally made with fixed cushion 16 such that fixed cushion 16 and support 20 effectively form one piece. In other embodiments, support 20 may be integrally made with moveable cushion 18 such that moveable cushion 18 and support 20 effectively form one piece. In still other embodiments, support 20 may be made separate from fixed cushion 16 and moveable cushion 18 and be later assembled with either of fixed cushion 16 or moveable cushion 18 depending on the configuration desired.

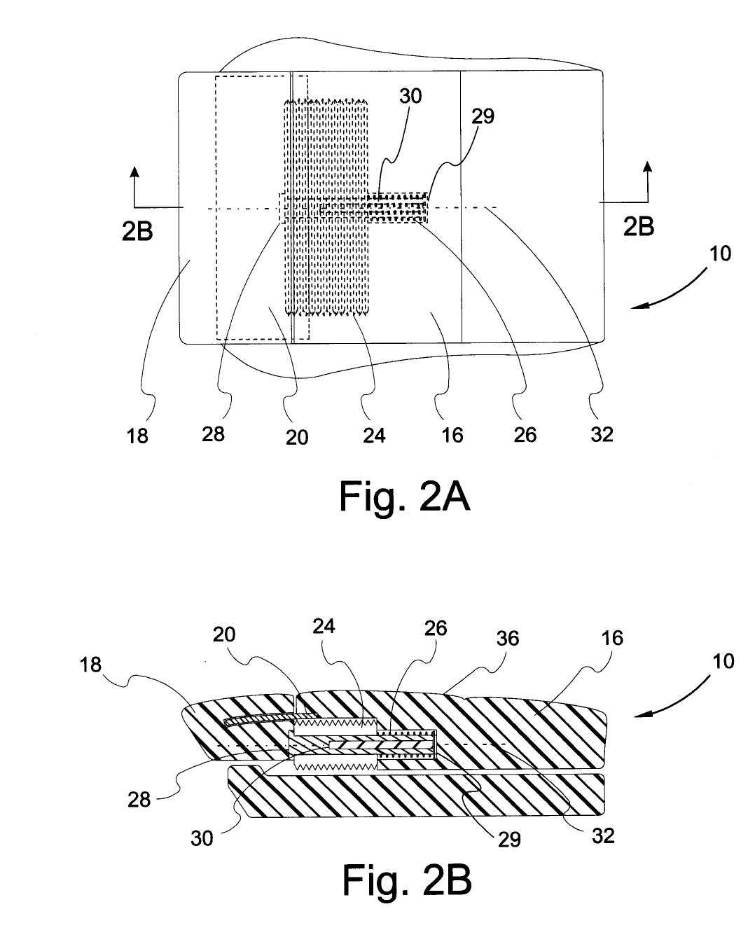

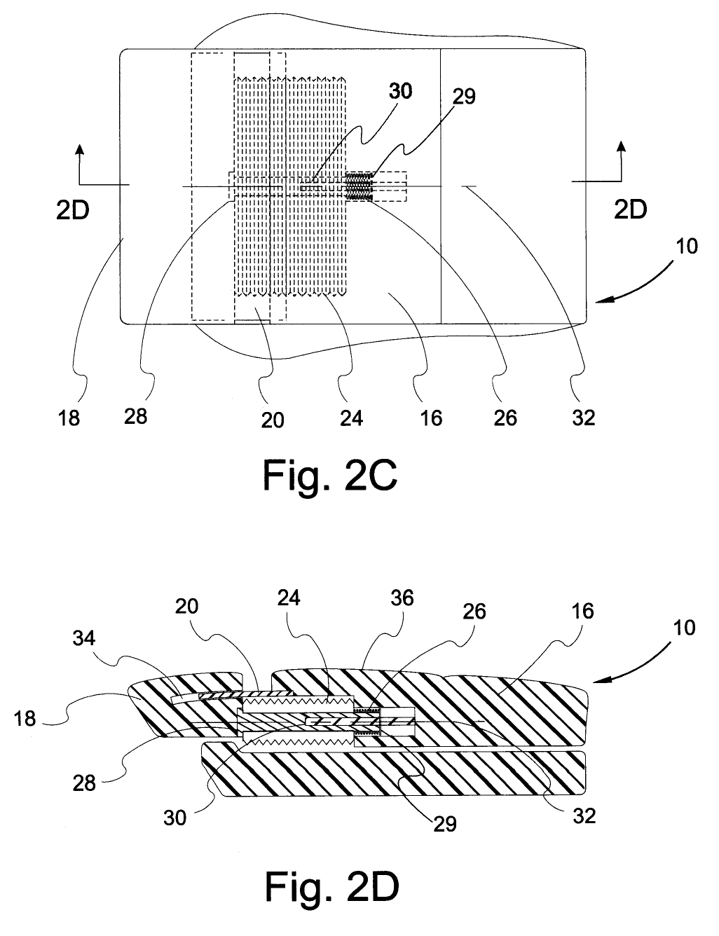

FIG. 2A is a plan view of a portion of seat 10 showing seat 10 in the retracted position. Seat 10 further includes inflatable bladder 24 and spring 26 for moving moveable cushion 18 relative to fixed cushion 16 as described below.

FIG. 2B is a side view, in cross-section, of seat 10 of FIG. 2A taken along section line 2B-2B of FIG. 2A and shows the mechanism used to move moveable cushion 18 in the retracted position. Spring 26 is wound around guide member 28 and disposed between inflatable bladder 24 and lip 29 of guide member 28. Guide member 28 is anchored with moveable cushion 18, in any conventional fashion, e.g., bolted, such that if guide member 28 moves, moveable cushion 18 moves. Guide member 28 includes a female portion that receives post 30. Post 30 is anchored with fixed cushion 16 in any conventional fashion, e.g., bolted. Guide member 28 is moveable relative to post 30. Inflatable bladder 24, which in this embodiment, is configured to allow guide member 28 and post 30 to pass through it, is located between fixed cushion 16 and moveable cushion 18. As inflatable bladder 24 expands, e.g., filled with air, guide member 28 and moveable cushion 18 move toward the extended position and lip 29 will compress spring 26 against inflatable bladder 24. Compressed spring 26 thus stores energy that may be used to return moveable cushion 18 and guide member 28 to the retracted position.

FIG. 2C is another plan view of a portion of seat 10 showing seat 10 in the extended position. In the extended position, support 20 is exposed, inflatable bladder 24 is inflated, and spring 26 is compressed as described above FIG. 2D is a side view, in cross-section, of seat 10 of FIG. 2C taken along section line 2C-2C and shows the mechanism used to move moveable cushion 18 in the extended position. As inflatable bladder 24 inflates, using any suitable pneumatic device, e.g., a pump, guide 28 moves relative to post 30 along axis 32 thus compressing spring 26. As guide 28 moves, moveable cushion 18 moves relative to fixed cushion 16 thus increasing the depth of seat 10 and exposing support 20.

If occupant 12 moves seat 10 from the extended position to the retracted position, inflatable bladder 24 deflates and the force from compressed spring 26 moves guide 28 and moveable cushion 18 toward fixed cushion 16 along axis 32. Moveable cushion 18 may be positioned at any location between the retracted and extended positions.

In the embodiment of FIG. 2D, moveable cushion 18 includes female portion 34 which accommodates support 20 as moveable cushion 18 moves relative to fixed cushion 16. In other embodiments, if support 20 is associated with moveable cushion 18, fixed cushion 18 would include female portion 34 to accommodate support 20. Additionally, in the embodiment of FIG. 2D, seat 10 further includes trim cover 36 that does not cover support 20. Support 20 has its own covering. In alternative embodiments, support 20 may be covered by cover 36 or constructed from such a material, e.g., plastic, fabric, such that no cover 36 is used.

Any conventional device, e.g., control panel, may be used to control the movement of moveable cushion 18. An occupant input interface, e.g., buttons (not shown), may be positioned on seat 10 which, in the embodiment of FIGS. 2A-2D, control the inflation and deflation of bladder 24 via any suitable pneumatic device, e.g., pump. Other occupant input interfaces may be used and located as desired. In embodiments where, for example, a motor and mechanical linkages are used to move moveable cushion 18, the occupant input interfaces may be operatively connected with such motor and mechanical linkages. Further configurations are also contemplated.

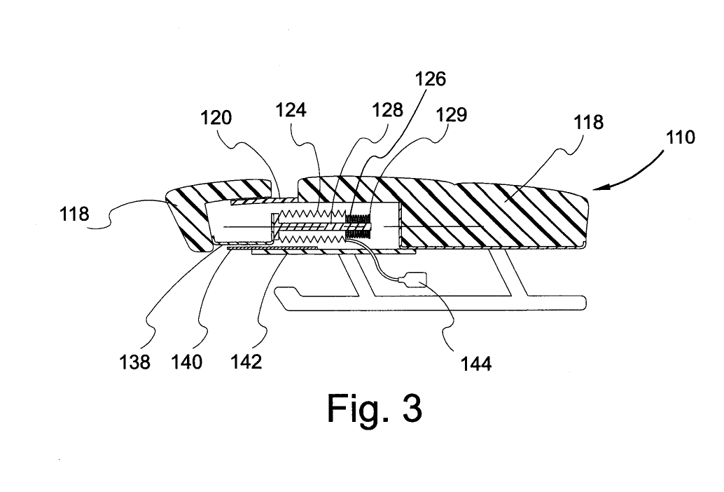

FIG. 3 is a side view, in cross-section, of an alternative embodiment of seat 110 showing the mechanism used to move moveable cushion 118 in the extended position. Numbered elements that differ by 100 have similar descriptions, e.g., 16 and 116 are fixed cushions. Moveable cushion 118 and guide member 128 are connected with bracket 138. Slide 140 is attached with bracket 138 such that if bracket 138 moves, slide 140 moves. Slide 140 slides within track 142 if moveable cushion 118 is moving between the retracted and extended positions. Pump 144 is located underneath seat 110. Pump 144, however, may reside in any suitable location.

In the embodiments described above, pneumatic devices, e.g., inflatable bladder 124 and pump 144, were used to move moveable seats 10, 110 between their retracted and extended positions. Any suitable device, however, e.g., motor, gear, etc., may be used to move seats 10, 110 between their retracted and extended positions.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat system for an occupant of a vehicle comprising:
a first element for supporting a first portion of the occupant in a seated position, the first element including one of a male portion and a female portion; and
a second element for supporting a second portion of the occupant in the seated position, the second element being moveable relative to the first element between a first position and a second position, the second element including the other of the male portion and the female portion;
wherein the male portion is generally exposed to the occupant if the second element is in the second position and wherein the female portion is configured to receive the male portion.

2. The system of claim 1 wherein the first element comprises a seat cushion.

3. The system of claim 1 further comprising a pneumatic device associated with the second element for moving the second element relative to the first element.

4. The system of claim 1 further comprising an inflatable device associated with the second element for moving the second element relative to the first element.

5. The system of claim 4 wherein the inflatable device comprises a bladder.

6. The system of claim 1 further comprising a spring associated with the second element for moving the second element relative to the first element.

7. The system of claim 1 wherein the second element is moveable relative to the first element along an axis.

8. The system of claim 1 wherein the first element includes a trim cover, and wherein the trim cover does not cover the male portion.

9. The system of claim 1 wherein the male portion supports at least a portion of the occupant in the seated position if the second element is in the second position.

10. The system of claim 1 wherein the male portion is generally hidden from the occupant if the second element is in the first position.

11. A seat system for an occupant of a vehicle comprising:
first and second portions that cooperate to define a seating surface, the second portion being moveable relative to the first portion between first and second positions; and
a third portion that is hidden if the second portion is in the first position and exposed if the second portion is in the second position, the third portion cooperating with the first and second portions to define a seating surface if the second portion is in the second position.

12. The system of claim 11 wherein the first portion comprises a seat cushion.

13. The system of claim 11 further comprising a pneumatic device associated with the second portion for moving the second portion relative to the first portion.

14. The system of claim 11 further comprising an inflatable device associated with the second portion for moving the second portion relative to the first element.

15. The system of claim 14 wherein the inflatable device comprises a bladder.

16. The system of claim 11 further comprising a spring associated with the second portion for moving the second portion relative to the first element.

17. The system of claim 11 wherein the second portion is moveable relative to the first portion along an axis.

18. The system of claim 11 wherein the third portion supports at least a portion of the occupant if the second portion is in the second position.

19. The system of claim 11 further comprising a spring associated with the second portion for moving the second portion relative to the first portion and an inflatable device associated with the second portion for moving the second portion relative to the first portion, the spring and inflatable device being disposed generally along an axis.

20. The system of claim 11 wherein the third portion and one of the first and second portions are integrally formed.
